(19) United States
(12) Patent Application Publication
(10) Pub. No.: US 2018/0373351 A1
(43) Pub. Date: Dec. 27, 2018

(54) INPUT DEVICE, AND INPUT SYSTEM EMPLOYING SAME

(71) Applicant: Panasonic Intellectual Property Management Co., Ltd., Osaka (JP)

(72) Inventors: Masaki SAWADA, Osaka (JP); Masahisa NIWA, Osaka (JP); Takefumi INOUE, Nara (JP); Hideki TAKAHASHI, Osaka (JP); Toshihiro KONISHI, Hyogo (JP)

(21) Appl. No.: 15/777,799

(22) PCT Filed: Nov. 16, 2016
(86) PCT No.: PCT/JP2016/004896

§ 371 Date: May 21, 2018

(30) Foreign Application Priority Data
Dec. 4, 2015 (JP) 2015-237071

(51) Int. Cl. G06F 3/0362; H01H 19/04; H01H 19/14; H01H 19/00; G06F 3/038

(52) U.S. Cl. CPC G06F 3/0362; H01H 19/04; H01H 19/14; G06F 3/044; G06F 3/0383; H01H 2019/006; H01H 2239/026; H01H 19/005

(57) ABSTRACT

An input device of the present disclosure has a stationary part, an operation input part that is provided above the stationary part, and is movable with respect to the stationary part, a detector configured to detect information regarding operation of the operation input part, and an attachment part provided in the stationary part so as to project downward from a second surface of the stationary part. The attachment part has a holder and a coupler configured to couple to the stationary part. A holding force maintaining a state where the holder is attached to an object is smaller than a coupling force between the coupler and the stationary part. When a force is applied to the holder from above, the holding force of the holder allows the holder to be fixed to the object.

### TECHNICAL FIELD

The present disclosure relates to an input device and an input system for use in an input operation input part of various electronic devices.

### BACKGROUND ART

In order to perform setting and adjustment of various functions, far example, a rotational operation type input device is used as an input operation input part of various electronic devices. A conventional rotational operation type input system has an input device, a movable electrode, and a display device, as described in PTL 1. The input device is configured, for example, by a rotational operation type knob. The display device is configured, for example, by a touch panel. The display device is one example of an attachment object, to which the input device is attached. The movable electrode (a terminal) is provided in the rotational operation knob. In this case, the rotational operation knob (a rotational operation element) is provided on a display screen of the touch panel. When the movable electrode (the terminal) slides on an upper surface of the touch panel, a sensor electrode inside the touch panel serve as a fixed electrode (a terminal).

In this case, the movable electrode rotationally moves, by which a value of electrostatic capacitance between the movable electrode and the fixed electrode is changed.

Accordingly, the rotational movement of the movable electrode causes electrical change to appear in the fixed electrode. This electrical change is supplied to a signal processing circuit inside the touch panel. The signal processing circuit can detect the rotational operation of the rotational operation knob by detecting the electrical change in the fixed electrode. That is, a detection signal in the conventional input system is supplied to the signal processing circuit of the touch panel through the movable terminal and the sensor electrode of the touch panel.

### CITATION LIST

### Patent Literature

PTL 1: Unexamined Japanese Patent Publication No. 2012-35782

### SUMMARY OF THE INVENTION

An input device of the present disclosure has a stationary part having a first surface and a second surface located below the first surface, an operation input part that is provided above the first surface of the stationary part, and is movable with respect to the stationary part, a detector configured to detect information regarding operation of the operation input part, and an attachment part provided in the stationary part so as to project downward from the second surface of the stationary part. The attachment part has a holder attachable to an object, and a coupler configured to couple to the stationary part. A holding force maintaining a state where the holder is attached to the object is smaller than a coupling force between the coupler and the stationary part. When a force is applied to the holder from above, the holding force of the holder allows the holder to be fixed to the object.

An input system of the present disclosure has the foregoing input device and a display device as an object. The display device has a display screen, the input device is detachable with respect to the display screen, and a position of the display screen at which the input device is attached is changeable.

### BRIEF DESCRIPTION OF THE DRAWINGS

FIG. 1 is a conceptual diagram of an input system in the present exemplary embodiment.

FIG. 2 is a perspective view of the input system in the present exemplary embodiment.

FIG. 3 is a top view of the input system in the present exemplary embodiment.

FIG. 4 is a side view of the input system in the present exemplary embodiment,

FIG. 5 is a side view of the input system in the exemplary embodiment.

FIG. 6 is an exploded perspective view of an input device in the exemplary embodiment.

FIG. 7A is a cross-sectional view showing the input system in a state where the input device of the exemplary embodiment is attached to a display device.

FIG. 7B is a cross-sectional view showing the input system in a state where the input device of the exemplary embodiment is temporarily fixed to the display device.

FIG. 7C is a cross-sectional view showing a state where the input device of the exemplary embodiment is fixed to the display device.

FIG. 8A is a cross-sectional view showing a state where the input device of the exemplary embodiment is attached to the display device.

FIG. 8B is a cross-sectional view showing a state where the input device of the exemplary embodiment is temporarily attached to the display device.

FIG. 8C is a cross-sectional view showing a state where the input device of the exemplary embodiment is fixed to the display device.

FIG. 9A is a partially enlarged view of a modification of the input device of the exemplary embodiment.

FIG. 9B is a partially enlarged view of the modification of the input device of the exemplary embodiment.

### DESCRIPTION OF EMBODIMENT

Prior to description of an exemplary embodiment of the present disclosure, conventional problems will be briefly described

In the foregoing conventional input system, when the input device is attached to the touch panel, fluctuation and variation occur in a gap between the movable electrode that the input device has, and the touch panel. Accordingly, there is a possibility that variation in the detected electrostatic capacitance between the movable electrode and the fixed electrode occurs. That is, in the conventional input system, there is a possibility that the rotational operation of the rotational operation knob cannot be accurately detected. Furthermore, a configuration is such that in order to reduce variation in detection accuracy of the electrostatic capacitance, the rotational knob can only slide on a touch panel screen, and the rotational knob is not detachable with respect to the touch panel.

The present disclosure provides an input device and an input system that are easily detachable with respect to an attachment object (a touch panel or the like), and are capable of detecting a state of operation accurately in a state attached to the attachment object.

Hereinafter, an input device and an input system according to the present exemplary embodiment will be described.

### Exemplary Embodiment

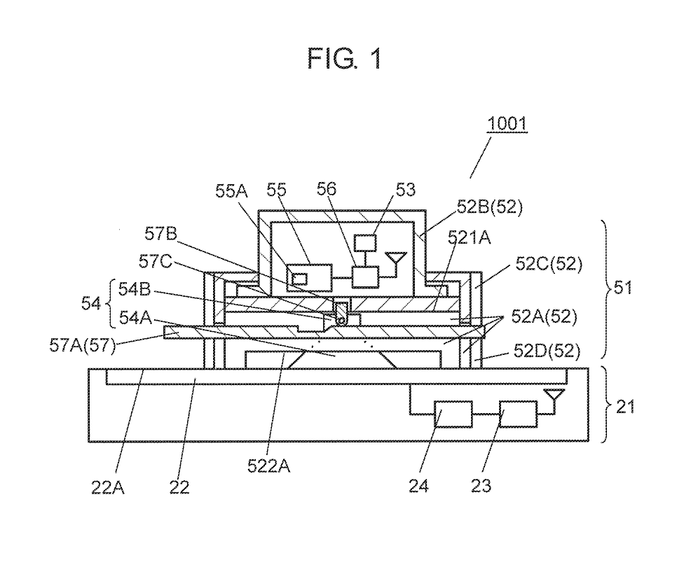

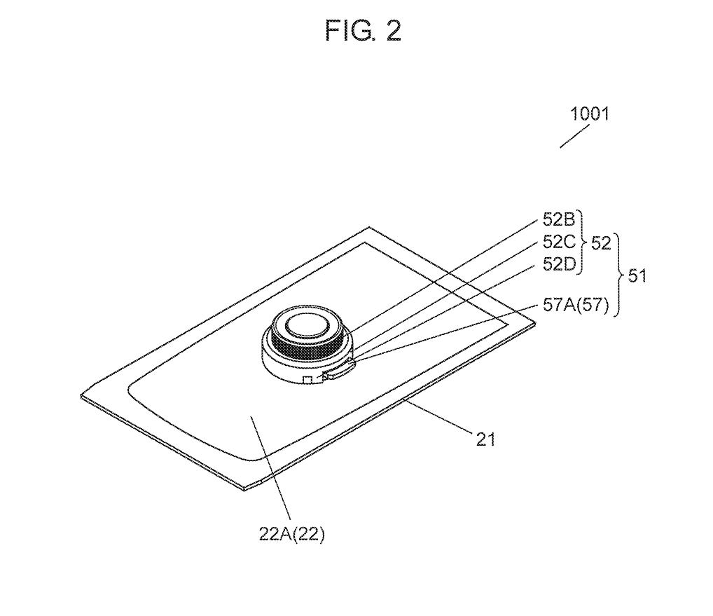

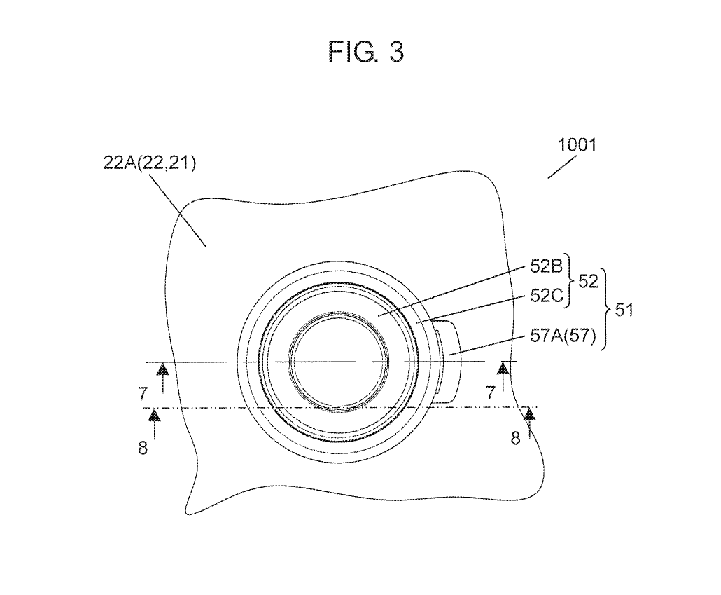

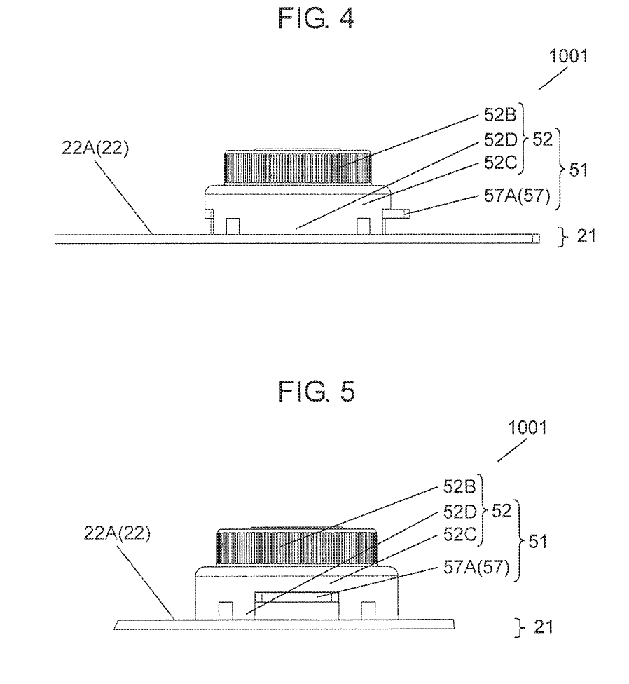

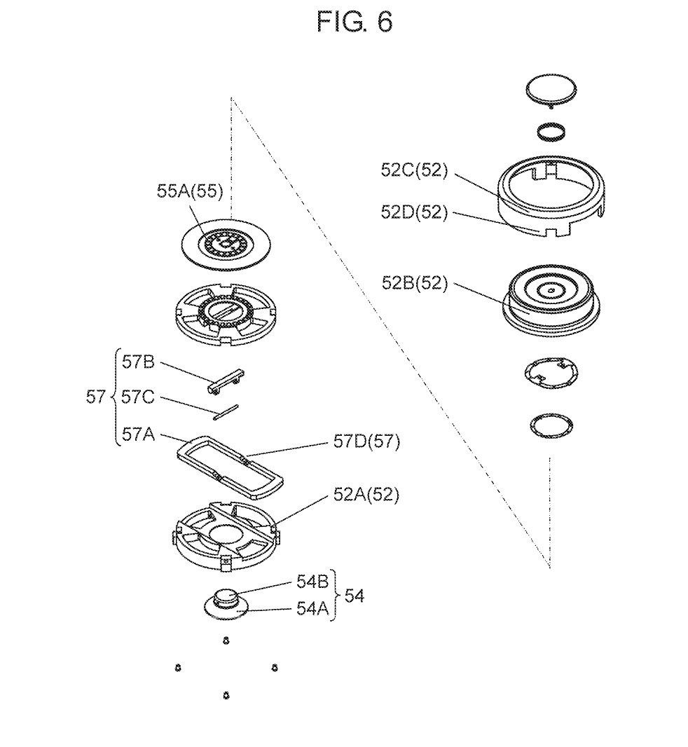

Hereinafter, input system 1001 according to the present exemplary embodiment will be described with reference to FIGS. 1 to 6. FIG. 1 is a conceptual diagram of input system 1001. FIG. 2 is a perspective view of input system 1001. FIG. 3 is a top view of input system 1001, FIG. 4 is a side view of input system 1001. FIG. 5 is a side view of input system 1001. FIG. 6 is an exploded perspective view of input device 51.

Input system 1001 has display device 21 and input device 51. Display device 21 has display 22 on a surface thereof, and display screen 22A is formed in a surface of display 22. Input device 51 is attached onto a surface of an attachment object (display screen 22A). In the present exemplary embodiment, display device 21 is the attachment object. FIG. 1 is a schematic view, and only a main configuration is shown and a part of the configuration is omitted.

Next, input device 51 will be described with reference to the drawings. As shown in FIG. 1, input device 51 has case 52 (configured by stationary part 52A, operation input part 52B, cover 52C, position maintaining part 52D, and the like), detector 53, and attachment, part 54. As shown in FIG. 6, cover 52C and position maintaining part 52D are integrally formed, an upper portion is represented as cover 52C, and a lower portion in contact with display screen 22A is represented as position maintaining part 52D.

Here, as shown in FIG. 1, a surface on an upper side of stationary part 52A is represented as a surface 521A, and a surface on a lower side of stationary part 52A is represented as a surface 522A.

Operation input part 52B can move with respect to stationary part 52A. FIG. 1 is a schematic view, and while in FIG. 1, the surface on the upper side (surface 521A) of stationary part 52A and the surface on the lower side (surface 522A) of stationary part 52A each look like a flat surface, actually, the upper surface and the lower surface of stationary part 52A each are not one flat surface as shown in FIG. 6.

Display device 21 is disposed below surface 522A. Operation input part 52B is provided above surface 521A. Detector 53 is provided inside case 52. Detector 53 detects information regarding operation of operation input part 52B, and outputs the information regarding the operation as a sensing signal.

Input device 51 is detachable with respect to display device 21. Accordingly, attachment part 54 is disposed so as to project downward from the surface on the lower surface side (surface 522A) of stationary part 52A. Attachment part 54 has holder 54A and coupler 54B. Holder 54A is attachable to display screen 22A. Accordingly, input device 51 can be attached to display screen 22A. Holder 54A can generate a holding force capable of maintaining a state where input device 51 is attached to display screen 22A (hereinafter, referred to as a “holding force”). In the present exemplary embodiment, input device 51 is attached to display screen 22A by adsorption or adhesion of holder 54A. Coupler 54B is coupled to stationary part 52A. Coupler 54B is located in an upper portion of attachment part 54, and holder 54A is located in a lower portion of attachment part 54. When a force is applied to holder 54A, the holding force generated in holder 54A maintains the state where input device 51 is attached to display device 21. As the force applied from above, weighting by a weight of input device 51 itself can be cited. The holding force of holder 54A is smaller than a coupling force between coupler 54B and stationary part 52A.

With the above-described configuration, in the input system of the present disclosure, when a force is applied to input device 51 in a direction where input device 51 is detached from display screen 22A, coupler 54B is not detached from stationary part 52A, but holder 54A is detached from display screen 22A. Accordingly, input device 51 can be easily detached from display screen 22A. That is, input device 51 can be detached from display device 21 in a state where attachment part 54 is coupled to stationary part 52A. In other words, input device 51 can be easily attached to display screen 22A at an arbitrary position. Input device 51 can be easily attached to/detached from display screen 22A at an arbitrary position any number of times, and the position in display screen 22A at which input device 51 is attached can be easily changed.

When input device 51 is repeatedly attached/detached with respect to display screen 22A, there is a possibility that variation occurs in height or the like of attachment part 54 when input device 51 is attached to the attachment object (display device 21). However, since in the present exemplary embodiment, input device 51 has detector 53, when the information regarding the operation of operation input part 52B is sensed, there is no influence by the variation in height of attachment part 54. Accordingly, regardless of the variation in height of attachment part 54 or the like, the information regarding the operation of operation input part 52B can be stably sensed.

Moreover, in the present exemplary embodiment, even if an operator (not shown) who operates input device 51 carries display device 21 in an inclined manner, input device 51 can be prevented from coming off from display device 21. Thus, as to the input device and the input system in the present exemplary embodiment, the operator can operate input device 51 regardless of a position of display device 21.

Hereinafter, input system 1001 will be described in more detail. Input device 51 transmits the sensing signal detected in detector 53 to display device 21. It is preferable that the sensing signal is transmitted to display device 21 by a radio signal. Input device 51 has power supply 55 and radio transmitter 56. Radio transmitter 56 is electrically connected to detector 53 and power supply 55. For example, the sensing signal outputted from detector 53 is transmitted to a signal input terminal (not shown) of radio transmitter 56. Radio transmitter 56 has a power supply terminal (not shown). Power supply 55 supplies a voltage for driving radio transmitter 56 to the power supply terminal. In this case, it is preferable that display device 21 has radio part 23, signal processor 24, and display 22. Radio part 23 receives the radio signal transmitted from radio transmitter 56 and converts the radio signal to a sensing signal. Radio part 23 is electrically connected to signal processor 24. The sensing signal received by radio part 23 is supplied to signal processor 24. Display 22 is electrically connected to signal processor 24. Display 22 has display screen 22A in an outer surface.

With the above-described configuration, since the sensing signal is transmitted to display device 21 from input device 51 by radio, there is no influence by variation in height of attachment part 54 when input device 51 is attached to display device 21, so that the sensing signal can be stably transmitted from input device 51 to display device 21. As a result, display device 21 can stably detect the information (the sensing signal) of the operation of operation input part 52B Moreover, in the input system in the present exemplary embodiment, wiring connecting between input device 51 and display device 21 is not required.

The present disclosure is not limited to the configuration in which the sensing signal is transmitted to display device 21 by radio, but the sensing signal may be transmitted to display device 21 by wire such as a cable and the like. In the case where the sensing signal is transmitted to display device 21 by wire such as a cable, radio transmitter 56 is not required. When input device 51 requires a driving voltage, the driving voltage can be supplied to input device 51 from display device 21 through a cable or the like. In this case, input device 51 need not have power supply 55.

Signal processor 24 can sense the operation (an operation direction, an operation amount or the like) of operation input part 52B by the sensing signal from input device 51. Signal processor 24 may display the information regarding the sensed operation (the operation direction, the operation amount or the like) on display 22. Displaying the information regarding the operation on display 22 enables the operator to virtually check the operation (the operation direction, the operation amount or the like) of operation input part 52B. In the case where input device 51 is of a rotational operation type, as shown in FIG. 3, as the information regarding the operation, a rotation direction and a rotation angle are employed.

As display device 21, a tablet terminal can be used. Display device 21 only needs to have display 22, and is not limited to the tablet terminal. For example, display device 21 may be configured by a display device and the like of a smartphone, a personal computer, a car navigation device, a television receiver, and the like. Moreover, it is preferable that display 22 has the touch panel. A configuration may be such that a command or data can be inputted into display device 21 directly from the touch panel. In this case, even if input device 51 does not properly operate or even if input device 51 is lost, the command or the data can be inputted into display device 21.

Next, input device 51 will be described in detail. As input device 51, there is a rotational operation type input device, as shown in FIG. 2. An input method of input device 51 is not limited to the rotational operation, but may be pushing operation. Moreover, the input method of input device 51 may be a method of input by linear operation. In the method of input by linear operation, operation input part 52B moves linearly with respect to stationary part 52A. For example, input device 51 may be configured such that the input into operation input part 52B is performed by the pushing operation or slide operation. It is preferable that detector 53 can sense not only the operation amount but the operation direction.

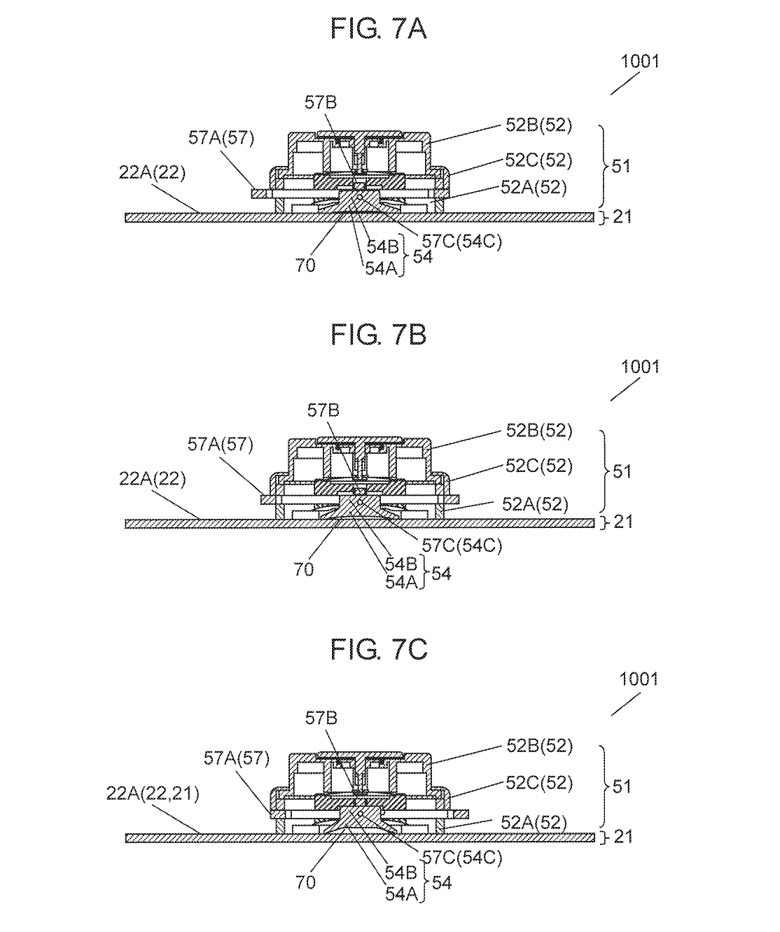

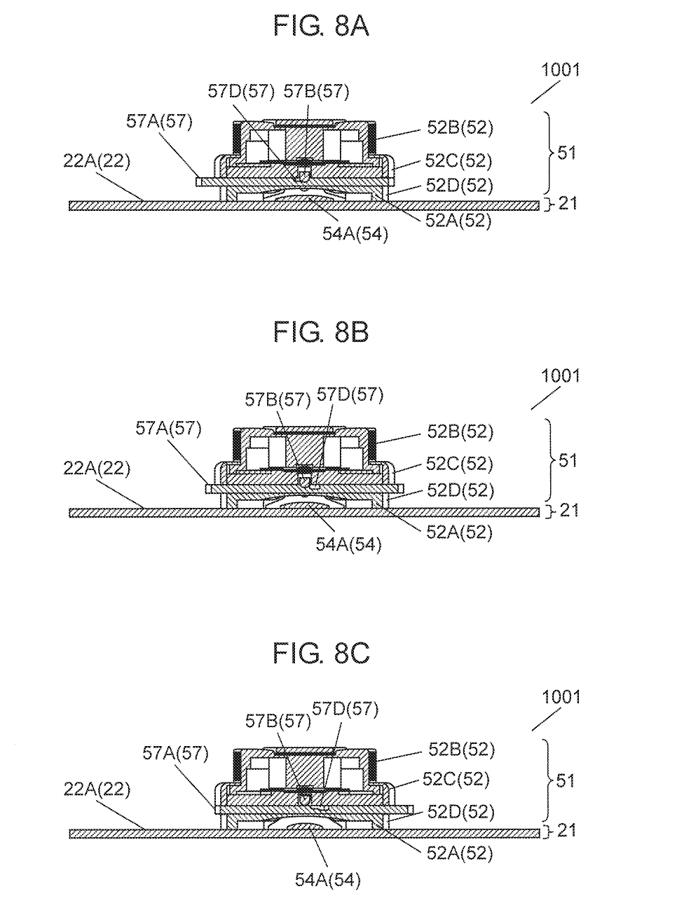

Hereinafter, as an example, a case in which input device 51 is of a rotational operation type will be described with reference to FIGS. 6 to 8C. FIG. 6 is an exploded perspective view of input device 51. FIG. 7A is a cross-sectional view of input device 51 in the state where input device 51 is attached to display 22. FIGS. 7A to 7C are cross-sectional views of input system 1001 along line 7-7 in FIG. 3, FIG. 7A shows the state where input device 51 is attached to display 22, FIG. 7B shows a state where input device 51 is temporarily fixed to display 22, and FIG. 7C shows a state where input device 51 is fixed to display 22. FIGS. 8A to 8C are cross-sectional views of input system 1001 along line 8-8 in FIG. 3, FIG. 8A shows the state where input device 51 is attached to display 22, FIG. 8B shows the state where input device 51 is temporarily fixed to display 22, and FIG. 8C shows the state where input device 51 is fixed to display 22.

Operation input part 52B can rotationally move with respect to stationary part 52A. In this case, detector 53 senses the rotational operation (a rotating length, the rotation direction and the like). Therefore, detector 53 is generally configured by a detection structure using an encoder. Detector 53 may use any detection method of, for example, mechanical rotation detection, optical rotation detection, further magnetic rotation detection and the like. Further, detector 53 may combine a plurality of sensing methods described above.

Mechanical detection is formed by, for example, a fixed contact and a movable brush. The movable brush rotates in contact with the fixed contact in conjunction with the operation of the operation input part. Magnetic detection can be formed by, for example, a combination of a magnet and a hall element, or a combination of a magnet and an MR element. Optical detection can be formed by a light-emitting element, a light-receiving element, a shutter, and the like. The shutter passes or blocks light from the light-emitting element in accordance with the operation of the operation input part.

It is preferable that case 52 further has cover 52C. Cover 52C is coupled to stationary part 52A. Cover 52C is disposed on an upper surface side of stationary part 52A. As shown in FIG. 6, cover 52C has a through hole in a center of a top surface. Operation input part 52B penetrates the through hole, and projects from the top surface of cover 52C. Operation input part 52B has a cylindrical side wall. Operation input part 52B has a top surface at one end portion of a side surface. On the other hand, at an end portion opposed to the top surface in the side wall, a flange projecting outward from the side wall is formed. The flange prevents operation input part 52B from coining off from cover 52C.

It is preferable that power supply 55 has generator 55A. Power supply 55 has generator 55A, by which input device 51 can output the sensing signal to display device 21 even though input device 51 does not have a battery. Moreover, when power supply 55 has a battery, even if a voltage of the battery decreases, input device 51 can output the sensing signal to display device 21. Further, in the case where power supply 55 does not use the battery exchange of the battery can be made unnecessary.

It is preferable that attachment part 54 is a sucker. Configuring attachment part 54 by the sucker makes it easy to change the position at which input device 51 is attached to display device 21. Moreover, display screen 22A can be restrained from being damaged. The sucker easily causes the variation in height of attachment part 54 when input device 51 is attached to display device 21. However, input device 51 incorporates detector 53 (refer to FIG. 1), so that the sensing signal can be transmitted to display device 21 by radio or by wire. Accordingly, even when the variation in height of attachment part 54 occurs, display device 21 can accurately detect the operation of operation input part 52B. It is preferable that holding force adjuster 57 is disposed on stationary part 52A.

Holding force adjuster 57 of the present exemplary embodiment is configured by operation lever 57A, actuator 57B, and fixture 57C, as shown in FIG. 6. Cam 57D is formed in operation lever 57A. Holding force adjuster 57 can adjust the holding force by operation of operation lever 57A.

As shown in FIGS. 7A and 8A, in the attached state, holder 54A generates the holding force of input device 51 to display screen 22A only by a suction force of the sucker alone. This state is referred to as the “attached state”.

Holding force adjuster 57 increases a degree of vacuum of space 70 enclosed by the sucker (holder 54A) and display screen 22A, which makes the holding force in the temporarily fixed state or the fixed state larger than the suction force by the sucker alone. That is, the degree of vacuum of space 70 enclosed by the sucker (holder 54A) and display screen 22A is higher in the temporarily fixed state shown in FIG. 7B than that in the attached state shown in FIG. 7A, and further is higher in the fixed state shown in FIG. 7C than that in the temporarily fixed state shown in FIG. 7B. Accordingly, the holding force of holder 54A to display screen 22A is larger in the temporarily fixed state shown in FIG. 7B than that in the attached state shown in FIG. 7A. Furthermore, the holding force of holder 54A to display screen 22A is larger in the fixed state shown in FIG. 7C than that in the temporarily fixed state shown in FIG. 7B.

Moreover, in the present exemplary embodiment, the holding force can be changed between the state where input device 51 is fixed to display device 21 and a state where input device 51 is detached from display device 21. Accordingly, input device 51 can be easily detached from display device 21. Moreover, input device 51 can be firmly fixed to display device 21.

A spring (not shown) presses actuator 57B (refer to FIG. 6) toward operation lever 57A. This configuration allows actuator 57B to move in up-and-down directions along cam 57D (refer to FIG. 6) with movement of operation lever 57A. Fixture 57C allows coupler 54B and actuator 57B to be coupled. Fixture 57C is formed of, for example, a pin made of metal, and coupler 54B is provided with through hole 54C. Fixture 57C penetrates through hole 54C of coupler 54B to couple both end portions of fixture 57C to actuator 57B, by which coupler 54B and actuator 57B are coupled. The coupling between coupler 54B and actuator 57B is not limited to the foregoing coupling method. Coupler 54B and actuator 57B may be coupled by bonding or the like.

### [Attached State]

Attachment part 54 shown in FIGS. 7A and 8A is located at a bottom dead center by cam 57D. In this state, input device 51 is attached to display screen 22A. That is, input device 51 is held to display screen 22A by an adsorption force of the sucker (attachment part 54) alone. Input device 51 can be detached from display screen 22A.

### [Temporarily Fixed State]

Next, the temporarily fixed state will be described with reference to FIGS. 7B and 8B. When operation lever 57A is moved, coupler 54B is moved upward by cam 57D. Consequently, since coupler 54B moves upward in the state where holder 54A is adsorbed to display screen 22A, the holding force becomes larger.

### [Fixed State]

Next, the fixed state will be described with reference to FIGS. 7C and 8C. When operation lever 57A is further moved, since coupler 54B is further moved upward in the state where holder 54A is adsorbed to display screen 22A, the holding force further becomes larger.

As described above, cam 57D can change the holding force in three stages.

The present disclosure is not limited to the configuration in which the holding force is changed in the three stages as in the present exemplary, embodiment, but a configuration may be such that the holding force is changed in two stages of the attached state and the fixed state. Further, a configuration may be employed in which cam 57D changes the holding force in four or more stages.

Moreover, attachment part 54 is not limited to the sucker, but may be a magnet, an adhesive sheet, or the like. In the case where attachment part 54 is configured by a magnet, display device 21 only needs to have a plate-shaped magnetic body (not shown). In this case, the magnetic body is disposed on a side of a surface opposed to display screen 22A of display 22 (a lower surface in FIG. 7A).

Attachment part 54 is located at the bottom dead center by cam 57D in the state where holder 54A is attached to display screen 22A.

With the movement of operation lever 57A, coupler 54B is moved upward by cam 57D. It is preferable that holder 54A is in contact with display screen 22A in the state where the attachment part 54 is located at the bottom dead center. The present disclosure is not limited to the configuration in which holder 54A and display screen 22A are in contact in the state where attachment part 54 is located at the bottom dead center, but a configuration in which there is a gap may be employed.

As shown in FIGS. 8A to 8C, it is preferable that input device 51 has position maintaining part 52D.

Position maintaining part 52D is provided outside stationary part 52A. A portion projecting downward from cover 52C is referred to as position maintaining part 52D. In the state where input device 51 is fixed to display device 21, position maintaining part 52D abuts on display screen 22A. Thus, when operation input part 52B is operated, the state when input device 51 is fixed can be easily maintained.

Position maintaining part 52D may be disposed with a gap with respect to display screen 22A in the state where input device 51 is fixed to display device 21. In this case, when operation input part 52B is operated, position maintaining part 52D may be caused to abut on display screen 22A, and the state where input device 51 is fixed to the display device may be allowed to be maintained.

It is preferable that position maintaining part 52D is located outside an outer circumferential end of stationary part 52A. This configuration can make smaller inclination of input device 51 when operation input part 52B is operated. It is preferable that position maintaining part 52D is provided all over outside the outer circumferential end of stationary part 52A. As to a direction in which the operator brings down operation input part 52B, this configuration can make smaller the inclination operation input part 52B, from whatever direction the operator applies force.

### [Modification of Input Device 51 (Input Device 100)]

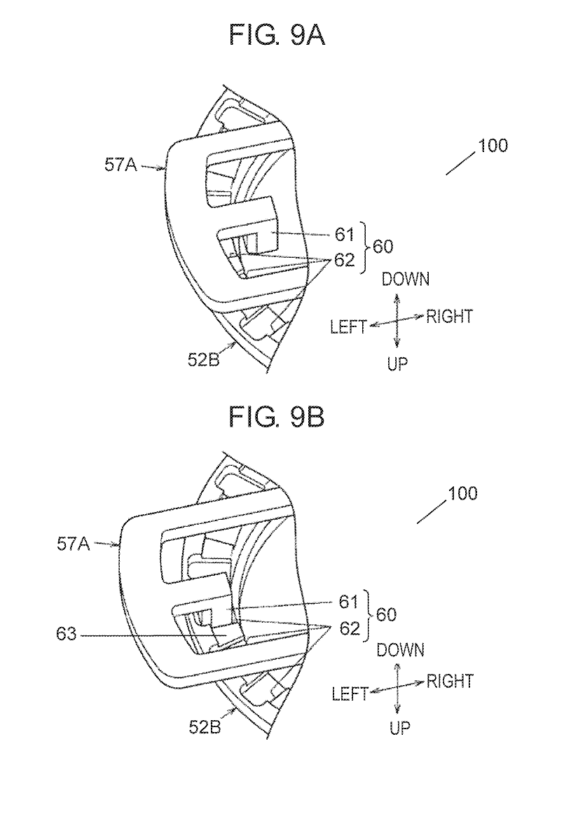

Here, a modification of foregoing input device 51 (input device 100) will be described with reference to FIGS. 9A and 9B.

FIGS. 9A and 9B are views when operation lever 57A and operation input part 52B are viewed from below. FIG. 9A shows a state where the sensing signal can be transmitted from radio transmitter 56 (refer to FIG. 1), and FIG. 9B shows a state where the sensing signal can be inhibited from being transmitted from radio transmitter 56 (refer to FIG. 1). A plurality of grooves 62 are formed in a lower surface of the flange portion of operation input part 52B. Engagement part 61 is formed in operation lever 57A. Engagement part 61 is provided in operation lever 57A. When operation lever 57A moves, engagement part 61 engages with groove 62. With this configuration, the operation of operation lever 57A can restrain the rotation of operation input part 52B. Accordingly, even if in a state where the operator does not attach input device 51, the operator erroneously operates input device 51, the sensing signal can be prevented from being erroneously transmitted from radio transmitter 56 (refer to FIG. 1).

It is preferable that respective grooves 62 and protrusions 63 are arranged at constant intervals. With this configuration, operating operation lever 57A in a state where the operator completes the operation can restrain the rotation of operation input part 52B.

As described above, according to the present exemplary embodiment, when a force is applied in a direction in which input device 51 is detached from display screen 22A (the attachment object), coupler 54B is not detached from input device 51 but holder 54A is detached from display screen 22A. Accordingly, input device 51 can be easily detached from display screen 22A. Input device 51 can be detached from display screen 22A (the attachment object) in the state where attachment part 54 is coupled to input device 51. Accordingly, input device 51 can be attached to display screen 22A (the attachment object) at an arbitrary position any number of times. Moreover, since the operation of operation input part 52B can be sensed in detector 53, even when input device 51 is repeatedly attached/detached, there is no influence by the variation in height of attachment part 54 when input device 51 is attached to display screen 22A (the attachment object), so that the information regarding the operation of operation input part 52B can be accurately sensed.

Further, according to the present exemplary embodiment, when the operator uses display device 21 while holding display device 21, even if input device 51 is held in an inclined position, input device 51 can be restrained from coming off from display device 21. Moreover, when display device 21 is installed somewhere and used, in whatever the position display device 21 is installed, input device 51 can be restrained from coming off from display device 21 (the attachment object). Accordingly, the operator can perform input work with input device 51 regardless of the position of the attachment object.

### (Summary)

Input device 51 of the present exemplary embodiment has stationary part 52A having surface 521A and surface 522A located below surface 521A, operation input part 52B that is provided above surface 521A of stationary part 52A, and is movable with respect to stationary part 52A, detector 53 configured to detect the information regarding the operation of operation input part 52B, and attachment part 54 provided in stationary part 52A so as to project downward from surface 522A of stationary part 52A. Attachment part 54 has holder 54A attachable to the object (e.g., display device 21), and coupler 54B configured to couple to stationary part 52A. The holding force maintaining the state where holder 54A is attached to the object (e.g., display device 21) is smaller than the coupling force between coupler 54B and stationary part 52A. When a force is applied to holder 54A from above, the holding force of holder 54A allows holder 54A to be fixed to the object (e.g., display device 21).

The information regarding the operation of input device 51 in input device 51 of the present exemplary embodiment may be the rotation angle and the rotation direction of operation input part 52B.

Moreover, attachment part 54 in input device 51 of the present disclosure may be the sucker.

Input device 51 of the present exemplary embodiment further has holding force adjuster 57 capable of adjusting the holding force.

Moreover, input device 51 of the present exemplary embodiment further has position maintaining part 521) provided outside the outer circumference of stationary part 52A. Position maintaining part 52D is provided so that input device 51 maintains the position in the state fixed to the object (e.g., display device 21).

Moreover, input device 51 of the present exemplary embodiment further has power supply 55, and radio transmitter 56 electrically connected to detector 53 and power supply 55 to output, as the radio signal, the sensing signal detected in detector 53.

Moreover, power supply 55 in input device 51 of the present exemplary embodiment has generator 55A.

Moreover, input device 51 of the present exemplary embodiment has operation lever 57A, and transmission inhibitor 60 configured to inhibit the sensing signal from being transmitted from radio transmitter 56 in conjunction with the movement of operation lever 57A.

Moreover, the input system of the present exemplary embodiment has foregoing input device 51 and display device 21 as the object.

In the present exemplary embodiment, terms indicating directions, such as “upper”, “lower”. “upper surface”, “lower surface”, “above”, “below”, “upper portion”, “lower portion” and the like only indicate relatively positional relationships, and the present disclosure is not limited thereto.

### INDUSTRIAL APPLICABILITY

An input system according to the present disclosure has an effect that an input device can be easily attached to a display device, such as a touch panel and the like, at an arbitrary position. The input device according to the present disclosure is useful when used as an input device attached to the display device to input data by operation of an operator or the like.

### REFERENCE MARKS IN THE DRAWINGS

21 display device (attachment object)
22 display
22A display screen
23 radio part
24 signal processor
51 input device
52 case
52A stationary part
521A, 522A surface
52B operation input part
52C cover
52D position maintaining part
53 detector
54 attachment part
54A holder
54B coupler
54C through hole
55 power supply
55A generator
56 radio transmitter
57 holding force adjuster
57A operation lever
57B actuator
57C fixture
57D cam
60 transmission inhibitor
61 engagement part
62 groove
63 protrusion
70 space
100 input device
1001 input system

1. An input device comprising:
a stationary part having a first surface and a second surface located below the first surface;
an operation input part that is provided above the first surface of the stationary part and is movable with respect to the stationary part;
a detector configured to detect information regarding operation of the operation input part; and
an attachment part provided in the stationary part so as to project downward from the second surface of the stationary part,
wherein the attachment part includes:
a holder attachable to an object; and
a coupler configured to couple to the stationary part,
a holding force maintaining a state where the holder is attached to the object is smaller than a coupling force between the coupler and the stationary part, and
when a force is applied to the holder from above, the holding force of the holder allows the holder to be fixed to the object.

2. The input device according to claim 1, wherein the information regarding the operation of the input device is a rotation angle and a rotation direction of the operation input part.

3. The input device according to claim 1, wherein the attachment part is a sucker.

4. The input device according to claim 1, further comprising a holding force adjuster capable of adjusting the holding force.

5. The input device according to claim 1, further comprising an position maintaining part provided outside an outer circumference of the stationary part to allow the input device maintains a position in a state fixed to the object.

6. The input device according to claim 1, further comprising:
a power supply; and
a radio transmitter electrically connected to the detector and the power supply to output a sensing signal detected in the detector as a radio signal.

7. The input device according to claim 6, wherein the power supply has a generator.

8. The input device according to claim 7, further comprising:
an operation lever; and
a transmission inhibitor configured to inhibit the sensing signal from being transmitted from the radio transmitter in conjunction with movement of the operation lever.

9. An input system comprising:
the input device according to claim 1; and
a display device as an object,
wherein the display device has a display screen,
the input device is detachable with respect to the display screen, and
a position of the display screen at which the input device is attached is changeable.

10. The input system according to claim 9, wherein the attachment part is a sucker.

11. The input system according to claim 9, wherein the input device has a holding force adjuster capable of adjusting the holding force.

12. The input system according to claim 9, wherein the input device includes a position maintaining part provided outside an outer circumference of the stationary part so that the input device maintains a position in the state fixed to the object.

13. The input system according to claim 9,
wherein the input device further includes:
a power supply; and
a radio transmitter electrically connected to the detector and the power supply to output a signal detected in the detector as a radio signal, and
the display device further includes:
a radio part configured to receive the radio signal;
a signal processor electrically connected to the radio part; and
a display part electrically connected to the signal processor.

14. The input device according to claim 13, wherein e power supply has a generator.
